(19) United States
(12) Patent Application Publication
(10) Pub. No.: US 2009/0113667 A1
(43) Pub. Date: May 7, 2009

(54) ADAPTIVE DECORATIVE STAIR ROD AND BRACKETS

(76) Inventor: Aboolhassan Zoroufy, Los Altos Hills, CA (US)

Correspondence Address: MICHAEL BEST & FRIEDRICH LLP, ONE SOUTH PINCKNEY STREET, P O BOX 1806, MADISON, WI, 53701, US

(21) Appl. No.: 12/035,043

(22) Filed: Feb. 21, 2008

Related U.S. Application Data
(62) Division of application No. 11/380,997, filed on May 1, 2006, now abandoned.
Application No. 11/380,997 is a continuation of application No. 11/108,481, filed on Apr. 18, 2005, now abandoned.
(60) Provisional application No. 60/563,434, filed on Apr. 19, 2004.

(51) Int. Cl. A47G 27/06; E04F 19/00; F21S 8/00

(52) U.S. Cl. 16/12; 52/28; 362/146

(57) ABSTRACT

A decorative stair rod comprising a core rod, a decorative layer, and an clear outer layer. The decorative layer can be a decorative fabric, decorative wall paper, decorative paper, reflective material, luminous material, or other material. The stair rod can also contain a compressible layer between the core rod and the decorative layer.

### CROSS REFERENCE TO RELATED APPLICATIONS

This application is a divisional of U.S. patent application Ser. No. 11/380,997 filed May 1, 2006, which is a continuation of U.S. patent application Ser. No. 11/108,481 filed Apr. 18, 2005, which claims the benefit of U.S. Provisional Application. No. 60/563,434 filed Apr. 19, 2004. All cited applications are incorporated herein by reference.

### BACKGROUND

The present invention relates generally to stair rod brackets and to stair rods. Carpet runners or other floor coverings are releasably affixed to stairs using stair rod sets. Many stair rod sets sold today are used as a decorative accent to the stairs and carpet runners. The stair rod set serves a decorative function as well as a useful function in preventing slippage of the carpet runner on the stairs of a staircase. A staircase typically has a plurality of steps. Each step has a riser and a tread. The stair rod set typically includes a pair of brackets with each bracket fastened to the step of a staircase. The brackets are spaced from the edges of the carpet runner and fastened at opposite sides of the step. Stair brackets frequently have a top portion and a bottom portion. Often, the bottom portion is fastened to the riser and the tread of the step of the staircase. A rod extends over the carpet runner and is held between and by the pair of brackets. A pair of finials may be used in conjunction with the stair rod and pair of brackets with one finial attached to each bracket. The present invention allows for a number of decorative or lighting inserts to be used with stair rods and finials.

### SUMMARY OF THE INVENTION

The present invention provides a decorative stair rod comprising a core rod, a decorative layer, and an clear outer layer. The decorative layer can be a decorative fabric, decorative wall paper, decorative paper, reflective material, luminous material, or other material. In one embodiment the stair rod also contains a compressible layer between the core rod and the decorative layer. The compressible is suitably comprised of foam or a similar material.

In another embodiment the invention comprises an adaptive decorative finial. The final comprises a base, a decorative layer, and a clear finial cap. The decorative layer can be a decorative fabric, decorative wall paper, decorative paper, reflective material, luminous material, or other material. In another embodiment the base of the finial can also be made out of a clear material.

In still another embodiment of the invention, the invention provides a stair rod comprising a clear hollow rod and a lighting element. In another embodiment the stair rod comprises a hollow core rod and a lighting element. The lighting element is positioned in the interior of the hollow core rod or the clear hollow rod. The hollow core rod has lighting apertures that allow light to be transmitted from the interior of the hollow core rod to the exterior of the hollow core rod.

### BRIEF DESCRIPTION OF THE DRAWINGS

FIG. 1 shows one embodiment of the core rod of the present invention.

FIG. 2 shows one embodiment of the core rod of the present invention.

FIG. 3 shows one embodiment of the decorative stair rod of the present invention.

FIG. 4 shows one embodiment of the decorative stair rod of the present invention.

FIG. 5 shows one embodiment of the decorative stair rod of the present invention.

FIG. 6 shows one embodiment of the decorative stair rod of the present invention.

FIG. 7 shows one embodiment of the decorative finial of the present invention.

FIG. 8 shows one embodiment of a standard finial of the present invention.

FIG. 9 shows one embodiment of a standard finial of the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including”, “having” and “comprising” and variations thereof herein is meant to encompass the items listed thereafter and equivalents thereof as well as additional items and equivalents thereof.

### DETAILED DESCRIPTION OF THE INVENTION

The present invention provides stair rods and stair rod brackets of varying designs.

In one aspect of the invention, the invention provides stair rods and star rod finials of a design allowing for varying, and changeable materials to be inserted within the rod and finial, and be visible from the outside.

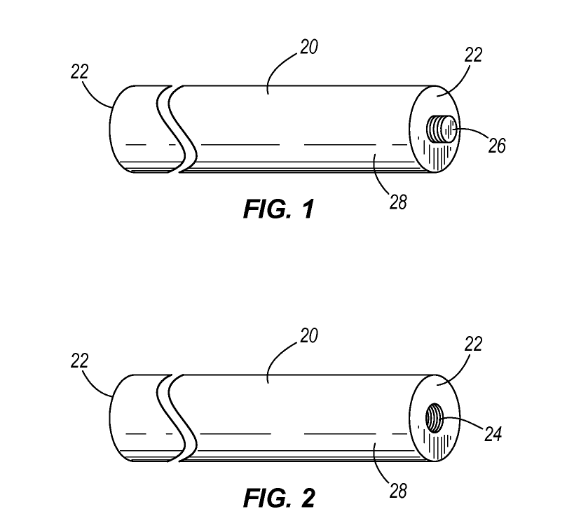

In one embodiment the invention (FIG. 4) provides an adaptive decorative stair rod 10 comprising a core rod 20 having an outer elongate surface 28 and two ends 22. The ends 22 of the core rod 20 can optionally have a threaded receiving aperture 24 (FIG. 2) or a threaded attachment rod 26 (FIG. 1). The core rod 20 is suitably comprised of a sturdy material. Such material can include metal, wood or plastic. The decorative stair rod 10 also comprises a decorative layer 30 having an outer surface 32 and an inner surface 34 (FIG. 4). The decorative layer 30 can be a decorative fabric, decorative wall paper, decorative paper, reflective material, luminous material, or other material. The inner surface 34 of the decorative layer 30 covers the outer elongate surface 28 of the core rod 20. The decorative stair rod 10 also comprises a clear outer layer 40 having an outer surface 42 and an inner surface 44. The clear outer layer 40 can also optionally have a threaded portion 46. The clear outer layer 40 is suitably comprised of a hard material such as plastic. The inner surface 44 of the clear outer layer 40 covers the outer surface 32 of the decorative layer 30. The clear outer layer 40 thus provides protection from damage to the decorative layer 30 and permits the decorative layer to be seen. The design of the stair rod 10 also allows for the decorative layer to be changed easily.

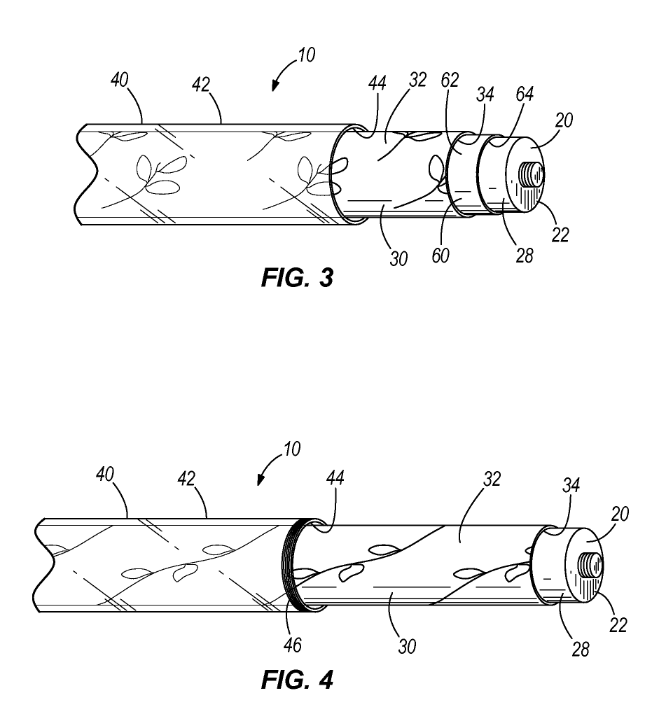

In another embodiment the decorative stair rod 10 also comprises a compressible layer 60 having an outer surface 62 and an inner surface 64 (FIG. 3). The inner surface 64 of the compressible layer 60 covers the outer elongate surface 28 of the core rod 20, and the inner surface 34 of the decorative layer 30 covers the outer surface 62 of the compressible layer 60. The compressible layer 60 is suitably comprised of foam or a similar material. In this embodiment the compressible layer covers at least a portion of the core 20.

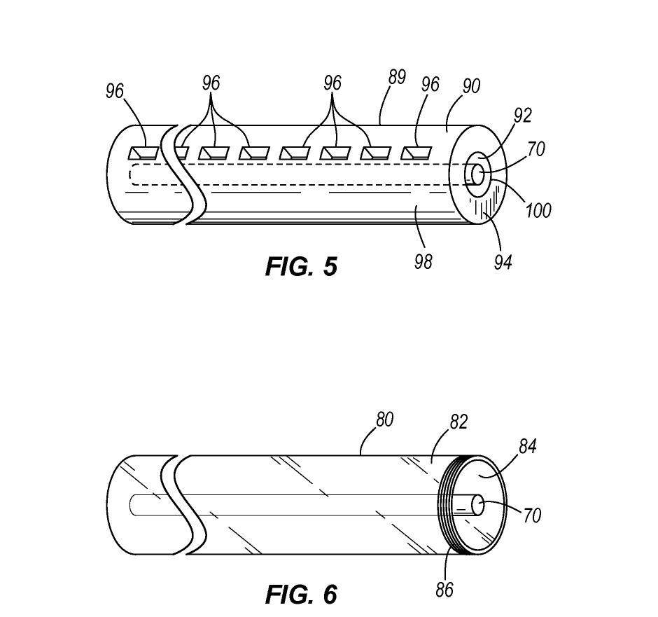

In still another embodiment of the invention, the invention provides a decorative stair rod comprising a hollow core rod 89 having an outside 90 and an inside 92, an outer elongate surface 98, ends 94 as well as an aperture 100 (FIG. 5). A lighting element 70 is positioned inside 92 the hollow core rod 89. Optionally, the hollow core rod can be covered by a clear outer later. The hollow core rod 89 is suitably made of a sturdy material. Such material can include wood metal or plastic. The hollow core has apertures 96 that allow light to be transmitted from the inside 92 of the hollow core rod 89 to the exterior of the hollow core rod. The lighting element 70 can be standard electrical bulbs which are commercially available, commercially available chemiluminescent material, or commercially available light emitting diodes (LEDs) or other commercially available light bulbs.

In yet another embodiment of the invention, the invention provides a stair rod comprising a clear hollow rod 80 having an outside 82 and an inside 84, and a lighting element 70 positioned inside 84 the clear hollow rod 80 (FIG. 6). The clear hollow rod 80 is suitably made a made from plastic and can optionally have a threaded portion 86.

The decorative stair rod 10 can be designed to be attached to standard finials 50 (FIGS. 8 and 9). In one embodiment, the core rod 20 has threaded receiving apertures 24 which can each receive a threaded attachment rod 56 connected to the base 52 of a finial 50 (FIGS. 2 and 8). In another embodiment, the core rod 20 has threaded attachment rods 26, which each can be received by threaded receiving aperture 54 in the base 52 of a finial 50 (FIGS. 3 and 9). In another embodiment, the clear outer layer 40 can have a threaded portion 46 which can be received by a threaded receiving aperture 54 in the base 52 of a finial 50.

The decorative stair rod can be designed so that the overall diameter of the decorative rod 10 is less than the diameter of the base 52 of the final 50. This design prevents the sideways movement of the core rod 20, compressible layer 60, decorative layer 30 and clear outer layer 40.

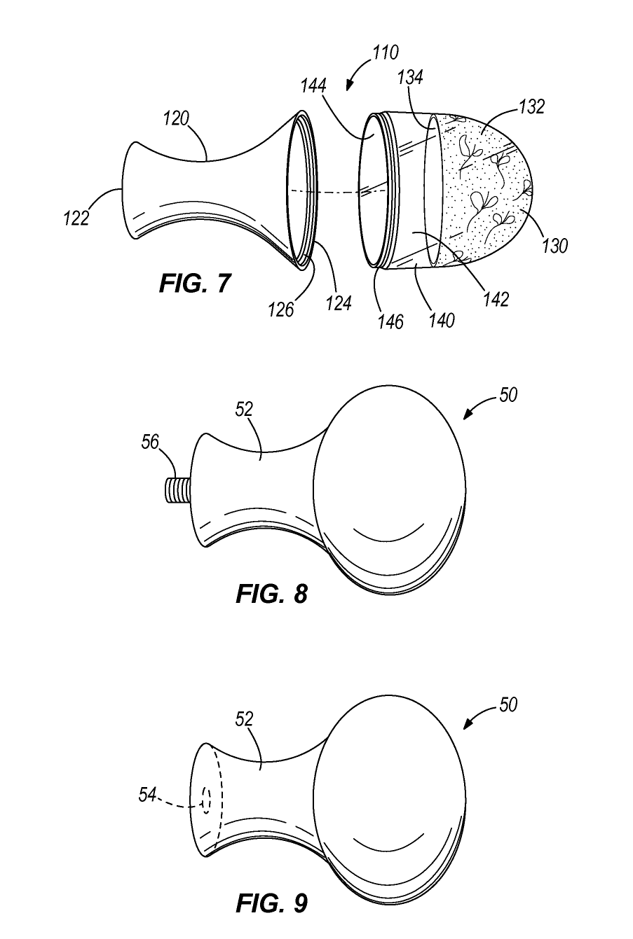

In another embodiment the invention comprises a decorative finial 110 comprising a base 120 having a first 122 and second 124 end (FIG. 7). The second end 124 of the base can have a threaded portion 126. The base 120 can suitably be made of any sturdy material, including wood, metal or plastic. The finial 110 further comprises a decorative layer 130 having an outer surface 132 and an inner surface 134. The decorative layer 130 can be a decorative fabric, decorative wall paper, decorative paper, reflective material, luminous material, or other material. The finial further comprises a clear finial cap 140 having an outer surface 142 and an inner surface 144. The clear finial cap 140 is suitably made of plastic or glass. The decorative layer 130 is placed within the clear cap 140, such that the decorative layer 130 is visible from the outside of the finial 110. The inner surface 134 of the finial cap 140 covers the outer surface 132 of the decorative layer 130. The finial cap 140 can be movably connected to the second end 124 of the finial base 120. This can be done by any standard fashion, including use of threads on the base 126 and the cap 146, such that the cap 140 can be screwed together with the base 120. The cap/base connection also can include the use of interlocking tabs on either, or both, the cap and the base.

In yet another embodiment of the invention, the invention provides a stair rod bracket set comprising a stair rod bracket and a finial. The bracket can be any standard stair rod bracket commercially available, including those listed in U.S. Pat. No.'s U.S. Pat. No. 484,708; U.S. Pat. No. 1,373,148; U.S. Pat. No. Des. 343,437; U.S. Pat. No. Des. 340,404; U.S. Pat. No. 5,960,516 incorporated herein by reference. The finial 110 comprises a base 120, a decorative layer 130, and a clear finial cap 140.

In still another embodiment the invention provides a stair rod kit comprising a stair rod bracket, a stair rod, and a finial. The bracket can be any standard stair rod bracket commercially available as listed above. The stair rod bracket 10 comprises a core rod 20, a decorative layer 30, and an clear outer layer 40. In one embodiment the stair rod also contains a compressible layer 60. The finial can comprise comprises a base 120, a decorative layer 130, and a clear finial cap 140.

While the present invention has now been described and exemplified with some specificity, those skilled in the art will appreciate the various modifications, including variations, additions, and omissions, that may be made in what has been described. Accordingly, it is intended that these modifications also be encompassed by the present invention and that the scope of the present invention be limited solely by the broadest interpretation that lawfully can be accorded the appended claims.

1. An adaptive decorative stair rod comprising:
a core rod having a first end, a second end and an outer elongate surface;
a decorative layer having an outer surface and an inner surface, wherein the inner surface of the decorative layer covers the a portion of the outer elongate surface of the core rod; and
a clear outer layer having an outer surface and an inner surface, wherein the inner surface of the clear outer layer covers the outer surface of the decorative layer.

2. The stair rod of claim 1 wherein the first and second ends of the core rod each have a threaded receiving aperture.

3. The stair rod of claim 2 further comprising a first and second finial, the first and second finial each having a base and threaded attachment rod attached to the base;
wherein the threaded attachment rod of the first finial is received by the threaded receiving aperture of the first end of the core rod; and
wherein the threaded attachment rod of the second finial is received by the threaded receiving aperture of the second end of the core rod.

4. The stair rod of claim 3 wherein the core rod, decorative layer and clear outer layer have a combined diameter and the base of the first and second finials each have a diameter; wherein the diameter of each of the first and second finials is greater than the combined diameter.

5. The stair rod of claim 1 wherein the first and second ends of the core rod each have a threaded attachment rod.

6. The stair rod of claim 5 further comprising a first and second finial, the first and second finial each having a base and threaded receiving aperture in the base;
wherein the threaded attachment rod of the first end of the core rod is received by the threaded receiving aperture of the first finial; and
wherein the threaded attachment rod of the second end of the core rod is received by the threaded receiving aperture of the second finial.

7. The stair rod of claim 6 wherein the core rod, decorative layer and clear outer layer have a combined diameter and the base of the first and second finials each have a diameter; wherein the diameter of each of the first and second finials is greater than the combined diameter.

8. The stair rod of claim 1, wherein the clear outer layer has a first threaded portion and a second threaded portion.

9. The stair rod of claim 8 further comprising a first and second finial, the first and second finial each having a base and threaded receiving aperture in the base;
wherein the first threaded portion of the clear outer layer is received by the threaded receiving aperture of the first finial; and
wherein the second threaded portion of the clear outer layer is received by the threaded receiving aperture of the second finial.

10. An adaptive decorative stair rod comprising:
a core rod having a first end, a second end, and an outer elongate surface;
a compressible layer having an outer surface and an inner surface; wherein the inner surface of the compressible layer covers a portion of the outer elongate surface of the core rod;
a decorative layer having an outer surface and an inner surface, wherein the inner surface of the decorative layer covers the outer surface of the compressible layer; and
a clear outer layer having an outer surface and an inner surface, wherein the inner surface of the clear outer layer covers the outer surface of the decorative layer.

11. The stair rod of claim 10 wherein the first and second ends of the core rod each have a threaded receiving aperture.

12. The stair rod of claim 11 further comprising a first and second finial, the first and second finial each having a base and threaded attachment rod attached to the base;
wherein the threaded attachment rod of the first finial is received by the threaded receiving aperture of the first end of the core rod; and
wherein the threaded attachment rod of the second finial is received by the threaded receiving aperture of the second end of the core rod.

13. The stair rod of claim 12 wherein the core rod, compressible layer, decorative layer and clear outer layer have a combined diameter and the base of the first and second finials each have a diameter; wherein the diameter of each of the first and second finials is greater than the combined diameter.

14. The stair rod of claim 13 wherein the first and second ends of the core rod each have a threaded attachment rod.

15. The stair rod of claim 14 further comprising a first and second finial, the first and second finial each having a base and threaded receiving aperture in the base;
wherein the threaded attachment rod of the first end of the core rod is received by the threaded receiving aperture of the first finial; and
wherein the threaded attachment rod of the second end of the core rod is received by the threaded receiving aperture of the second finial.

16. The stair rod of claim 15 wherein the core rod, compressible layer, decorative layer and clear outer layer have a combined diameter and the base of the first and second finials each have a diameter; wherein the diameter of each of the first and second finials is greater than the combined diameter.

17. The stair rod of claim 10, wherein the clear outer layer has a first threaded portion and a second threaded portion.

18. The stair rod of claim 17 further comprising a first and second finial, the first and second finial each having a base and threaded receiving aperture in the base;
wherein the first threaded portion of the clear outer layer is received by the threaded receiving aperture of the first finial; and
wherein the second threaded portion of the clear outer layer is received by the threaded receiving aperture of the second finial.

19. An adaptive decorative stair rod comprising a clear hollow rod having an inside, an outside, a first threaded portion and a second threaded portion; and a lighting element positioned inside the clear hollow rod.

20. The stair rod of claim 19 further comprising a first and second finial, the first and second finial each having a base and threaded receiving aperture in the base;
wherein the first threaded portion of the clear hollow rod is received by the threaded receiving aperture of the first finial; and
wherein the second threaded portion of the clear hollow rod is received by the threaded receiving aperture of the second finial.

21. An adaptive decorative stair rod comprising:
a hollow core rod having an inside, an outside, an elongate surface, a first end, a second end, and a plurality of lighting apertures on the elongate surface;
a lighting element positioned on the inside of the hollow core rod; and
a clear outer layer having an outer surface and an inner surface, wherein the inner surface of the clear outer layer covers the elongate surface of the hollow core rod.

22. The stair rod of claim 21 wherein the first end of the hollow core rod has an aperture.
